(19) United States
(12) Patent Application Publication
(10) Pub. No.: US 2007/0259168 A1
(43) Pub. Date: Nov. 8, 2007

(54) Process for producing wood/plastic composites and foams using foaming agents containing zeolite, and wood/plastic composites and foams produced thereby

(75) Inventor: Michael E. Reedy, Keyport, NJ (US)

Correspondence Address: HEDMAN & COSTIGAN P.C., 1185 AVENUE OF THE AMERICAS, NEW YORK, NY, 10036, US

(73) Assignee: Reedy Development LLC

(21) Appl. No.: 11/818,631

(22) Filed: Jun. 15, 2007

Related U.S. Application Data
(62) Division of application No. 11/273,922, filed on Nov. 15, 2005.

(51) Int. Cl. B32B 3/26

(52) U.S. Cl. 428/304.4

(57) ABSTRACT

The present invention relates to cellulosic material/polymer composites and foams containing zeolite, blowing agent(s) and masterbatch(es) for making such composites and foams, and processes therefor. More specifically, in the embodiments of the present invention directed to cellulosic material/polymer foams, the compositions comprise one or more zeolites and one or more foaming agents, wherein the foaming agent(s) preferably is carried by the zeolite(s) and evolves to form foamed products when processed with foamable materials. The present invention also comprises blowing agent composition(s) comprised of zeolite(s) and foaming agent(s) combination(s), and masterbatch composition(s) comprised of zeolite(s), foaming agent(s) and cellulosic material(s). The zeolite provides several benefits to such compositions and foams. The zeolites also have been found to reduce the tendency of the wood portion of the compositions and foams to discolor and have biocidal activity which reduces the tendency of the compositions and foams to degrade from bacterial and fungal attack.

### FIELD OF THE INVENTION

The present invention relates to cellulosic material/plastic composites and foams containing zeolite, zeolite-containing blowing agents and masterbatches, and processes for making such composites and foams. One of the preferred embodiments of the present invention is directed to cellulosic material/plastic foams, wherein the blowing agent or masterbatch composition comprises one or more zeolites, one or more foaming agents, and one or more cellulosic materials wherein the foaming agent(s) is carried by the zeolite(s) and evolves to form cellulosic material-containing foam when processed with foamable materials. In another preferred embodiment, the one or more foaming agent is added separately from any foaming agent carried by the zeolite. The present invention also comprises blowing agent composition(s) comprised of zeolite(s) and foaming agent(s), and masterbatch compositions comprised of zeolite(s), foaming agent(s) and cellulosic material(s). The zeolite(s) provides several benefits to such composites and foams. The zeolite(s) have been found to reduce the tendency of the cellulosic material portion of the composite(s) and foam(s) to discolor, and the zeolite(s) have biocidal activity which reduces the tendency of the compositions and foams to degrade from bacterial and fungal attack.

### BACKGROUND OF THE INVENTION

Foamed products, and in particular foamed polymer articles, are well known in the art and have many applications. Foams are used, for example, for cushioning, insulation (thermal as well as sound), protection (packaging), weight reduction, impact absorption and thermal, chemical and electrical inertness. Such applications include, for example, food packaging, building materials, wire insulation, coatings, and more. Foamed polymer articles are typically produced from foamable thermosetting resins, foamable thermoplastic resins or foamable elastomeric resins, both filled and unfilled, including using cellulosic materials as fillers. Thermoplastic polymer foams can be made using expanded beads or conventional polymer processing techniques like extrusion molding, injection molding, reactive injection and mechanical blending. Foam extrusion typically involves melting the foamable material in an extruder, adding a gas (or a compound that is in a gaseous state, or releases a gas, at extrusion temperature and standard pressure) or a source of a gas, e.g. a chemical compound that produces a gas upon decomposition, and then extruding the molten foamable material through a die to form foamed product. The process wherein a gas is used to foam the foamable material is called physical foaming, whereas the process wherein a chemical compound which decomposes is used to foam the foamable material is called chemical foaming. Often, nucleating agents are also added to the molten foamable material so as to improve the pore size and the homogeneity of the resulting foam product, by providing nucleation sites for the formation of bubbles during release of the foaming agent.

Many different polymers are known to produce foamed products and these include, for example, polystyrene, polypropylene, polyethylene, polyester and fluoropolymers. Such foamed products are of interest because of, inter alia, their superior heat resistance, chemical inertness, incombustibility, good dielectric properties and, in particular, insulating properties. The combination of cellulosic material and polymer to create a composite has been especially responsive to the high demand for alternatives to solid wood construction products which, generally, are increasingly more expensive to produce than cellulosic material/polymer composites. For example, polymer composites containing cellulosic material have been used in the area of picture, door, wall and window frames. Other uses, whether foamed or unfoamed, include decking, fencing, siding, dimensional lumber, boardwalks, railroad ties, pilings, guardrails, automotive parts (head liners, interior panels, spare tire covers, and the like), pallets, crates, playground equipment, parking lot car “stops”, benches, and tables. Injection molding or extrusion of the cellulosic material/polymer composite allows for uses in the furniture industry, such as for chairs, tables, and the like, as well as for uses in the automotive industry, such as when the desired components need to appear wood-like. The inclusion of cellulosic material in the extruded or injection molded polymer composite is convenient since these types of polymers are conventionally used in combination with a variety of lubricants, pigments and fillers. Notwithstanding their prior use and potential, cellulosic material/polymer composites and foams suffer from drawbacks, especially where a high loading of cellulosic material is desirable, such as discoloring due to processing conditions, and undesirable moisture absorption.

### SUMMARY OF THE INVENTION

According to its major aspects and broadly stated, the present invention is directed to blowing agent and masterbatch compositions containing zeolite, methods for making such blowing agent and masterbatch compositions, methods for using such blowing agent and masterbatch compositions to produce cellulosic material-containing composites and foamed products, and the composites and foams produced thereby.

More specifically, the present invention is directed to blowing agent and masterbatch composition(s) comprising one or more zeolite(s) and one or more foaming agent(s). The foaming agent(s) may be carried by the zeolite(s) and/or be present separately from the zeolite. The blowing agent and/or masterbatch composition is optionally mixed with cellulosic material and/or foamable material to form compositions which also may be used as blowing agents or masterbatches, or which may be added directly to an extruding or injection molding device to form a composite or foamed product containing the zeolite(s) and cellulosic material(s). The foaming agent(s), whether carried by the zeloite(s) or not, will evolve at a preselected temperature and pressure, such as those used in common injection and extrusion processes, to form cellulosic material-containing foamed product.

The foaming agent used can be any suitable material that will generate a gas when subjected to heating and pressure changes. When carried by the zeolite(s), the foaming agent is “trapped” by the zeolite structure when the zeolite is exposed to the foaming agent, and remains trapped until the conditions, such as temperature and pressure, are altered. The appropriate foaming agent(s) can be inherent to the zeolite or added to the zeolite(s) by any suitable means in which the zeolite(s) are exposed to the foaming agent(s) so that the foaming agent becomes “trapped” within the zeolite internal structure. “Trapped” means to bind a molecule by adsorption, absorption, or electrostatic attraction. The present invention is further directed to blowing agent and masterbatch compositions for use in preparing a foamable material(s), said blowing agent and/or masterbatch compositions comprised of zeolite(s) and foaming agent(s), wherein the foaming agent(s) are trapped by the zeolite(s). In addition, in a more specific embodiment, the present invention comprises method(s) for preparing cellulosic material-containing composites and foamed products, which methods comprise mixing blowing agent(s) with cellulosic material(s) and foamable material(s) to form a first mixture; changing the temperature and pressure of the first mixture to a preselected temperature and pressure so that the blowing agent(s) evolves a gas into the cellulosic material-containing foamable material, forming cellulosic material-containing foamed product(s). Once foaming has occurred, the cellulosic material-containing foamed product is solidified.

Alternatively, the blowing agent(s) may be first mixed with either cellulosic material(s) or foamable material(s) and the added to the remaining component(s), foamable material(s) or cellulosic material(s), as the case may be, to form the cellulosic material-containing composite or foamable product.

When the blowing agent or masterbatch composition is added to a foamable material (i.e., resins, plastics, rubbers or other foamable materials), the foaming agent is released by altering the temperature and pressure to those within a preselected range. The foaming agent(s) may be released from zeolite in a variety of ways. For example, the foaming agent(s) may be released from the zeolite by raising the temperature or lowering the pressure. When present in a cellulosic material-containing foamable material, the released foaming agent(s) forms bubbles that cause the foamable material to develop into a foamed product having a lo cellular structure. Accordingly, when the temperature is reduced the foamed product solidifies, leaving bubbles distributed throughout the foamed product. The blowing agent or masterbatch compositions can be prepared using any suitable zeolite(s), any suitable foaming agent(s) and, optionally, any suitable cellulosic material(s) and/or foamable material(s). Naturally occurring or synthetic zeolites containing water in their internal structure may be used as is or, because such zeolites are characterized by their ability to undergo dehydration with very little or no change in crystal structure, thereby providing a high internal surface area for trapping other molecules, the zeolite(s) may be partially, predominately, or completely dehydrated of any internally contained water, and permitted to trap some portion of one or more different foaming agent(s). As used above, the term “completely” means that at least substantially all of the water capable of being released from the zeolite is released so as to accommodate the one or more different foaming agent(s). In an alternative embodiment, a foaming agent separate from any foaming agent(s) trapped by the zeolite may be used as the foaming agent(s) in the embodiments of the present invention. For example, one or more hydrated or dehydrated zeolites may be used in combination with a solid blowing agent such as sodium bicarbonate (which releases CO2 as the foaming agent under suitable conditions known to those skilled in the art), or may be used in combination with a gaseous foaming agent such as any of the known organic gases (e.g., hexane, heptane and the like).

Accordingly, in view of the foregoing, one embodiment of the present invention is blowing agent and/or masterbatch compositions suitable for use in preparing cellulosic material-containing composite or foam, said blowing agent or masterbatch composition comprising zeolite, foaming agent and, optionally, cellulosic material. Of course, as indicated, more than one zeolite and/or more than one foaming agent and/or more than one cellulosic material may be present in the blowing agent and/or masterbatch composition, and in the appended claims, the singular includes the plural.

Another embodiment of the present invention is a process for producing cellulosic material-containing foamed product, said process comprising:
(a) heating foamable material(s) to a temperature above the melting point to form melted foamable material(s);
(b) adding to the melted foamable material(s) blowing agent or masterbatch composition comprised of zeolite(s) foaming agent(s) and cellulosic material(s);
(c) mixing the combination of foamable material(s) and blowing agent or masterbatch composition under conditions which retard foaming of the foamable material(s); and
(d) subjecting the combination of foamable material(s) and blowing agent(s) to conditions which induce release of the foaming agent(s).

It should be understood that the order of addition of the various components is not critical. For example, the zeolite(s) and foaming agent(s) may be added to all or a portion of the foamable material(s), either before or after such foamable material(s) are melted, and the cellulosic material(s) then added, or the zeolite(s) and foaming agent(s) may be added to all or a portion of the cellulosic material(s) and then added to the foamable material(s), either before or after the foamable material(s) are melted. And, if only a portion of the cellulosic material(s) or foamable material(s) are combined with the zeolite(s) and foaming agent(s), the remaining portion can be added at any time. Also, the cellulosic material(s) and foamable material(s) may be combined, in whole or in part, then melted, and thereafter the zeolite(s) and foaming agent(s) and any remaining cellulosic material(s) and/or foamable material(s) may be added.

Also, the mixtures of materials may exclude foaming agent(s) or may be subject to conditions, such as being pressed in a plate press, which prevent or substantially inhibit foaming and result in an essentially non-foamed cellulosic material-containing composite.

Preferably, alone or in combination, the heating, adding, mixing and subjecting are carried out as part of an injection molding or extrusion molding process. And, of course, more than one foamable material, more than one zeolite, more than one blowing agent, and more than one cellulosic material may be used in any of the processes for producing cellulosic material-containing foamed product, and may be present in the resulting foamed product. In the appended claims, the use of the singular includes the plural.

A further embodiment of the present invention is cellulosic material-containing composite or foamed product produced by any of the processes for producing a composite or foamed product. Preferably, the foamed product is a cellulosic material-containing foamed thermoplastic, although the present invention includes the use of thermosetting materials as well.

### DETAILED DESCRIPTION OF THE INVENTION

Zeolites are materials with discreet channels and cages that allow the diffusion of molecules into and out of their crystalline structures. The utility of these materials lies in their microstructures that allow access to large internal surface areas and that increase adsorptive and ion exchange capacity.

Solids, liquids or gases (preferably liquids and gases), are trapped by zeolites via strong physical and/or chemical forces, such as ionic forces, covalent forces and electrostatic attractions. These trapped solids, liquids, or gases can be released by the application of heat, change in pressure or by displacement with another material, leaving the crystal structure of the molecular sieve in the same chemical state as when the trapped solid, liquid or gas entered. The trapping and release are generally substantially completely reversible with the respective isotherm curves coinciding completely, or nearly so. Isotherm curves can be used to determine the manner in which to regulate the trapping and release of the foaming agent(s).

Zeolites possess a very high surface area; for example, the external surface area only comprises approximately one percent (1%) of the total surface area. The entire surface area of the zeolites is capable and available for trapping the foaming agent(s). Therefore, the external surface area of the zeolites is available for foaming agent(s) of all sizes, whereas the internal surface area is available only to molecules small enough to enter the pores. However, because the external surface comprises approximately one percent (1%) of the total surface area, materials too large to be trapped within the pores will usually only be held by the external surface to the extent of 0.2 to 1 weight percent.

The zeolite framework is made up of SiO2 tetrahedra linked by shared oxygen atoms. Substitution of aluminum for silicon creates a charge imbalance that requires a non-framework cation to balance the charge. These cations, which are contained inside the channels and cages of these materials, may be replaced by other cations giving rise to ion exchange properties. The water in these materials may typically be reversibly removed leaving the host structure intact, although some framework distortion may occur. In addition, these materials are typically alkaline. Suspensions of low SiO2.Al2O3 ratio materials in water often give rise to a pH greater than 9. This combination of alkalinity and the pore structure of these compounds is believed to be largely responsible for the ability of these zeolites to stabilize halogenated polymers by neutralizing acids released during processing and creating inert salts and/or scavenging excess cationic metals.

Zeolites are frequently categorized by their crystalline unit cell structure (See W. M. Meier, D. H. Olson, and Ch. Baerlocher, Atlas of Zeolite Structure Types, Elsevier Press (1996) 4th ed.). Those suitable for use in the present invention include compounds characterized as zeolite A, zeolite P, zeolite X, and zeolite Y. In the present invention, any suitable zeolite can be used to trap the desired foaming agent. The appropriate zeolite is dependent on the size, electronegativity and polarizability of the foaming agent desired to be trapped. Appropriate zeolites for the present invention include, but are not limited to, Type 3 A, 4 A, 5 A, 13X and combinations thereof (the A represents angstroms, and 13X has a pore size greater than 5 A).

A wide variety of zeolites are available, each with its own specific and uniform pore size. This variety allows for the zeolite to be chosen on the basis of the material to be trapped. Generalized pore size and adsorption characteristics of type 3 A, 4 A, 5 A and 13X molecular sieves are as follows: Type 3 A may be used to trap molecules with an effective diameter of less than 3 angstroms, including water and ammonia, and excludes molecules with a diameter of more than 3 angstroms, such as ethane; Type 4 A may be used to trap molecules with an effective diameter of less than 4 angstroms, including ethanol, hydrogen sulfide, carbon dioxide, sulfur dioxide, ethylene, ethane, and propene, and excludes molecules with an effective diameter greater than 4 angstroms, such as propene; Type 5 A may be used to trap molecules having an effective diameter of less than 5 angstroms, including n-butanol, n-butane, saturated hydrocarbons from methane to molecules containing twenty-two carbons, R-12, and excludes molecules having an effective diameter of greater than 5 angstroms, including iso-compounds and four carbon ring compounds; 13X may be used to trap molecules having an effective diameter less than 10 angstroms, and excludes molecules having an effective diameter greater than 10 angstroms. Each type molecular sieve may trap molecules of the lower type, i.e., Type 5 A may adsorb molecules adsorbed by Type 4 A, and so forth. However, trapping of the foaming agent(s) may be more efficient using a zeolite with pore size more closely analogous to the size of the molecule being trapped, especially in effective retention of the trapped foaming agent(s) prior to and during processing.

The zeolites useful in the present invention may be generally designated by the chemical formula M2/nO.Al2O3.ySiO2.wH2O in which M is a charge balancing, exchangeable cation, n is the valence of M and is 1 or 2, y is the number of moles of SiO2 and is about 1.8 to about 15, and w is the number of moles of water of hydration per molecule of the zeolite. Suitable charge balancing cations represented by M in the formula include such cations as sodium, potassium, zinc, magnesium, calcium, ammonium, tetra-alkyl and/or -aryl ammonium, lithium, Ag, Cd, Ba, Cu, Co, Sr, Ni, Fe, and mixtures thereof. The preferred cations are alkali metal and/or alkaline earth metal cations, with the proviso that, when M is a mixture of alkali or alkaline earth metals comprising sodium and potassium and/or calcium, the preferred potassium and/or calcium content is less than about 35% by weight of the total alkali or alkaline earth metal content.

The size and position of the exchangeable cation (Na, Ca, etc.) may affect the pore size in any particular type of zeolite. For example, the replacement of sodium ions in Type 4 A with calcium ions produces type 5 A, with a free aperture size of 4.2 angstroms. Not wishing to be bound by any theory, the cations are also probably responsible for the very strong and selective electronic forces which are unique to these adsorbents. In the case of zeolites, selectivity is influenced by the electronic effects of the cations in the cavity as well as the size of the apertures in the alumino-silica framework. Therefore, zeolites can be tailored to “trap” specific molecules by varying the size of the pores and the attractive forces.

As mentioned, zeolites will not only separate molecules based on size and configuration, but they will also trap preferentially based on polarity or degree of chemical unsaturation. Therefore, molecules are held more tightly in the crystal structure if they are less volatile, more polar, or less chemically saturated. Some of the strongest trapping forces are due to cations acting as sites of strong, localized, positive charge that electrostatically attract the negative end of polar molecules. Polar molecules are molecules containing heteroatoms such as O, S, Cl, F, or N and are usually asymmetrical. Dipole moments can also be induced by cations present in the zeolites, resulting in the attraction of sites of unsaturation over saturated bonds. In view of these means of attraction, the ability of zeolites to trap and hold the foaming agent is based not only on molecular size, but additionally on the basis of electronic forces. For example, zeolites will trap water in preference to argon and olefins in preference to saturated hydrocarbons.

While the number of moles of SiO2 per molecule of aluminosilicate, represented in the formula by y, may be in the range of about 1.8 or greater, it is suitably about 1.85 to about 15, more suitably about 1.85 to about 10, preferably in the range of about 2 to about 5, and more preferably in the range of about 1.8 to about 3.5. The number of moles of water in the zeolite as water of hydration, represented in the formula by w, is generally greater than about 0.1, more generally in the range of about 0.1 to about 10. It is desirable that the zeolite have a mean particle size in the range of about 0.1 to about 10 microns, suitably wherein at least about 90% of the particles are less than about 50 microns, advantageously less than about 25 microns, and more advantageously less than about 10 microns. It is also desirable that the zeolite have a mean micropore diameter in the range of about 2.8 to about 8 A, and/or an external surface area in the range of about 3 to about 300 square meters/g.

In the present invention, the most preferred zeolites are the ADVERA 401 PS, ADVERA 401P and ADVERA 401F sodium aluminosilicate hydrated type Na-A zeolite powders, all available from PQ Corporation. Each of the ADVERA zeolites has: an average nominal chemical composition of 17% Na2O, 28% Al2O3, 33% SiO2, and 22% H2O; a nominal pore size diameter of 4 A; and a moisture loss at 800 degrees C. of 18%-22% by weight. These zeolites vary somewhat in average particle size and particle size distribution.

Any suitable foaming agent(s) that can be trapped by zeolite(s) can be used to foam the foamable material when it is desired to use a zeolite(s) containing foaming agent(s) as the blowing agent(s) according to the present invention. Alternatively, as mentioned above, foaming agent(s) may be used separately from the zeolite(s), which may or may not themselves include foaming agent(s). Suitable foaming agents, for both being trapped by the zeolite and/or being used separately from any foaming agent(s) carried by the zeolite, include but are not limited to inert gases, saturated aliphatic hydrocarbons, saturated alicyclic hydrocarbons, aromatic hydrocarbons, halogenated hydrocarbons, and ethers, ketones, and alcohols (preferably from one to eight carbons in length). Examples of these foaming agents include water, carbon dioxide, nitrogen, methane, ethane, propane, butane, pentane, hexane, methylpentane, dimethylbutane, methylcyclopropane, cyclopentane, cyclohexane, methylcyclopentane, ethylcyclobutane, isopropyl alcohol, propyl alcohol, ethanol, butanol, isobutanol, sec-butanol, heptanol, pentanol, isopentanol, hexanol, 1,1,2-trimethylcyclopropane, dichlorodifluoromethane, monochlorodifluoromethane, trichlorotrifuoroethane, sulfur hexafluoride, dichlorotetrafluoroethane, dichlorotrifluoroethane, monochlorodifluoroethane, tetrafluoroethane, dimethyl ether, 2-ethoxy-acetone, methyl ethyl ketone, acetyl acetone, dichlorotetrafluorethane, monochlorotetrafluoroethane, dichloromonofluoroethane and difluoroethane. Although not all of the above mentioned foaming agents can be trapped by every one of the zeolites described above or in the preferred embodiment(s) of the present invention, generally, those skilled in the art may determine which foaming agent(s) can be used with any particular zeolite(s), either by general knowledge in the art, or by minor experimentation.

The cellulosic material(s) suitable for use in the present invention can be found in, for example, wood, paper and cotton. Such cellulosic material(s) can include wood fiber derived from soft woods (such as pine, spruce, fir and the like) or from hard woods (such as oak, ash, i 5 hickory and the like). Soft woods are generally preferred as a source for cellulosic material because the resulting fibers are longer than when hard woods are used, but both soft and hard woods are used in the examples herein. Other sources for cellulosic material(s) include wood flour, wood flakes, ground wood, wood veneers, wood laminates, paper, cardboard, sawdust, straw, alfalfa, wheat pulp, bamboo, cotton, flax, peanut shells, rice hulls, sugar cane and other known sources of cellulosic fibers. The cellulosic material(s) can also be found as recycled fibers derived from newspapers, boxes and the like. Wood fiber is commonly obtained from sawdust or wood shavings found at lumber mills.

The amount of cellulosic material loaded into the thermoplastic can be varied from about 1% to about 99% thereby varying the characteristic of the mixture. Preferably, the amount of cellulosic material is about 20% to about 80%, about 30% to about 70%, or about 40% to about 60%, depending upon the final use of the composite or foam. Most preferably, the amount of cellulosic material is about 50%. The lower the amount of cellulosic material loaded into the thermoplastic, the fewer wood-like characteristics will appear in the final product resulting in a more thermoplastic end-product. Generally, the more thermoplastic end-product would have characteristics more like a thermoplastic than like a wood product, for example, it would have increased water resistance. However, in one embodiment of the present invention, it is disclosed that through the use of the proper selection of components, water resistance can be maintained even where a higher loading of cellulosic material is used in the thermoplastic. Also generally, the higher the amount of cellulosic material loaded into the thermoplastic results in an end-product with a greater number of wood-like characteristics, such as a wood-like appearance or an increased ability to be painted or coated. A desired blend of characteristics from the cellulosic material and from the thermoplastic can be achieved by minor experimentation for any particular application by those skilled in the art, and by the examples which follow.

An optional component of the masterbatch mix is a rubbery block copolymer. These are known in the art generally as having the formulae: A-B, A-B-A, A-B-A-B, and the like, including graft and radial block copolymers, as well as block copolymers containing other types of blocks, “C”. These rubbery block copolymers of the above formulae generally contain a styrenic polymer as the “A” block, and generally contain a rubbery polymer, e.g. butadiene, ethylene/propylene, ethylene/butylene, isoprene, isobutylene as the “B” block. Block “C”, when present, may be either a second, different styrenic polymer from the “A” block or a second, different rubbery polymer from the “B” block, as the case may be. Preferred as the rubbery block copolymer in the masterbatch mix are those block copolymers available from Shell Chemical Company under the designations “Kraton G” and “Kraton D”, such as Kraton D-1101, Kraton D-1102 Kraton D-1107, Kraton G-1650, Kraton G-1651, Kraton G-1652, Kraton G-1657X, Kraton G-1701X, and Kraton G-1726X. Especially preferred are Keaton G-1650 and Kraton G-1652. The foregoing rubbery block co-polymers have the following approximate block and physical characteristics: a styrene-butadiene-styrene block copolymer having a styrene/rubber ratio of about 31/69 (Kraton D-1101); a styrene-butadiene-styrene block copolymer having a styrene/rubber ratio of about 28/72 (Kraton D-1102); a styrene-isoprene-styrene block copolymer having a styrene/rubber ratio of about 14/86 (Kraton D-1 107); a styrene-ethylene/butylene-styrene block copolymer having a styrene/rubber ratio of about 29/71 (Kraton G-1650); a styrene-ethylene/butylene-styrene block copolymer having a styrene/rubber ratio of about 32/68 (Kraton G-1651); a styrene-ethylene/butylene styrene block copolymer having a styrene/rubber ratio of about 29/71 and a ring and ball softening point (ASTME 28-67, 10% by weight in Kaydol oil) of about 141 degree F. (Kraton G-1652); a styrene-ethylene/butylene-styrene block copolymer having a styrene/rubber ratio of about 13/87 (Kraton G-1657X); a styrene-ethylene/propylene block copolymer having a styrene/rubber ratio of about 37/63 (Kraton G-1701X); and a styrene-ethylene/butylene block copolymer having a styrene/rubber ratio of about 30/70 (Kraton G-1726X). Also preferred as the rubbery block copolymer are the family of SIBS (styrene-isobutylene-styrene copolymers) sold under the tradename SIBSTAR by Kaneka Corporation. SIBSTAR 073T has a molecular weight of about 65,000 and a styrene/rubber ratio of about 30/70; SIBSTAR 103T has a molecular weight of about 100,000 and a styrene/rubber ratio of about 30/70; SIBSTAR 102T has a molecular weight of about 100,000 and a styrene/rubber ratio of about 15/85.

Foamable materials capable of being employed in the present invention and foamed with the blowing agent(s) include but are not limited to natural and synthetic thermoplastic and thermosetting resins, acrylonitrilebutadiene rubbers, viscous settable ceramic materials, polyolefins (for example, low and high density polyethylene and polypropylene), olefin copolymers (for example, copolymers of ethylene and ethylvinylacetate), polyaromatic olefins, styrenic compounds and polymerized halodiolefins (for example, neoprene), ethylene-propylene copolymers, polyvinyl chlorides, polycarbonates, polyesters, and polyalkenylaromatics (poly-alpha methylstyrene and polystyrene).

Additional additives such as lubricants, colorants, surfactants and the like may also be used in the blowing agent and masterbatch compositions and in the processes of the present invention.

An advantage of the blowing agent and masterbatch compositions comprising zeolite(s) carrying trapped foaming agents(s) is that the foaming agent(s) can be introduced into the resin prior to extrusion, thus eliminating the need for a separate gas injector. In addition, the zeolite(s) also function as a nucleation site, thus reducing or eliminating the need to add a separate nucleating agent, such as talc. Furthermore, the tendency of gas bubbles to combine in the foaming process to form non-uniform pockets of bubbles is decreased when zeolites are used to carry the foaming agent(s) because release of the foaming agent(s) is produced at the site of nucleation, the zeolite. The zeolites, being both uniform in size and the site of gas formation, result in uniform bubbles being formed in the foamed product.

Foamed products are prepared with the blowing agent and masterbatch compositions of the present invention by any of the known methods in the art. For example, the blowing agent or masterbatch is mixed with suitable foamable material(s) and/or cellulosic material(s) and extruded or molded by a suitable method, such as pressure molding, die molding, paste molding, calendar molding, extrusion molding or injection molding. Molding means forming an article by deforming the blowing agent/masterbatch-foamable/cellulosic material mixture in the heated molten state. The foamable blowing agent/masterbatch-foamable/cellulosic material mixture is added to the extruder through a hopper, where the mixture is thoroughly blended and exposed to heat to expand the foamable material and form a foamed product. Here again, the characteristics of the foamed product can be varied depending on the foaming conditions and the specific compositions used in the process.

The blowing agent/masterbatch-foamable/cellulosic material mixture can be used to create foam in single screw extrusion, multi-screw extrusion or tandem screw extrusion processes. Because of the nature of the zeolite structure, the blowing agent or masterbatch mixes more thoroughly with the foamable/cellulosic material to form a homogenous mixture than other gaseous foaming agents added via a gas injection system. Uniform mixing results in a consistent product with a uniform cellular structure.

During the foaming process, the blowing agent/masterbatch-foamable/cellulosic material is preferably exposed to temperatures and pressures that have been preselected for the specific foamable/cellulosic material and blowing agent/masterbatch employed and product characteristics desired. Preferably, the blowing agent/masterbatch-foamable/cellulosic material composition is exposed to high temperatures and pressures characterized as supercritical conditions. Supercritical conditions are conditions at which the gas is in a state of matter, being neither a gas, liquid or a solid, which exhibits unique qualities. Once the gas is exposed to supercritical conditions, gas passes to a low pressure zone in the extruder so that the foaming agent trapped within the zeolite (and/or present separately from the zeolite) is released, resulting in the foaming of the foamable material. Upon cooling, the desired foamed product is solidified, producing a uniform cellular structure. Any suitable method of foaming, injection molding or extruding known in the art may be used with the present blowing agent to form foamed resins.

The mixture of the blowing agent(s) or masterbatch(es) and the foamable material(s) and/or cellulosic material(s) may vary widely, depending on the characteristics of the foamed product desired. However, the blowing agent or masterbatch composition(s) is generally used in an amount of about 0.05% to about 50% by weight, preferably about 0.25% to about 20% by weight, and most preferably in an amount 0.5% to about 10% by weight, based on the weight of the total foamable material(s) employed. The temperature at which foaming occurs is dependent upon the blowing agent or masterbatch and the foamable material used, as well as the foamed product desired.

Different blowing agents may also be added to the foamable material to obtain desired foamed product characteristics. In addition, differing proportions of blowing agents can be combined to optimize the foam characteristics, such as flexibility, rigidity, strength and durability of the foamed product. Furthermore, by varying the rheology of the foamable material mixture, the temperature window for foaming certain foamable materials can be broadened, resulting in the foaming of certain foamable materials that have heretofore been difficult to foam. In addition, varying the blowing agent can affect such properties as the melt strength of the polymer to form sturdier products.

The following examples illustrate some of the preferred embodiments of the present invention, are not illustrative of any limitations to the present invention, and should not be construed to limit the invention claimed in the appended claims in any manner.

### EXAMPLES

A series of zeolite-containing additives were prepared and used in wood/thermoplastic mixtures to show the effectiveness of zeolite in enhancing the physical properties in both foamed and un-foamed wood/thermoplastic mixtures. The zeolite additives were as follows:
A—zeolite alone (Advera 401 PS)
B—zeolite (Advera 401 PS) combined with an oxidized polyethylene wax (CD935—available from Clariant Corporation) (ratio: 95% zeolite/5% wax)
C—zeolite (Advera 401 PS) combined with a modified polyethylene plastic dispersion (SEKUR CN 25—available from Reedy Int'l. Corporation). The SEKUR CN 25 was diluted to 1% concentration in water (4.95 parts water, 0.05 parts SEKUR), then mixed with 95 parts of the zeolite in a Henschel blender run at high speed for 2-3 minutes, and then dried.
D—zeolite (Advera 401 PS) combined with CD935 (ratio: 95% zeolite/5% wax) combined with SEKUR CN 25. The SEKUR CN 25 was again diluted to 1% concentration in water, as above, and then mixed with 95 parts of the zeolite/wax combination in a Henschel blender run at high speed for 2-3 minutes, and then dried.

### Example Set I

Additives A, B, C, and D were each added to cellulosic material (unbleached wood fiber) at percentages of 1%, 5%, 10%, 20%, 30%, and 40% and blended therewith, and the resulting wood/zeolite blends were added to high density polyetheylene (HDPE) in a ratio of 50%/50%. The resulting zeolite/wood/HDPE blends were extruded and the physical properties of impact strength, flexural modulus and elongation were tested. The physical properties of the zeloite/wood/HDPE products were improved as compared to a product produced from 50% wood/50% HDPE. In addition, the zeolite-containing compositions showed increased thermal stability, allowing processing at a temperature 40 degrees C. greater than the wood/HDPE compositions.

### Example Set II

Additive A was also added to a cellulosic material (oak wood fiber)/PVC composition (50%/50%) at varying percentages 1%-7% and a foamed product was obtained. A non-foaming product was produced by the addition of a water scavenger, in this case CaO. The water scavenger suppressed the foaming action of the water vapor released from the zeloite.

### Example Set III

Additives B and D were added at 1%, 2%, and 10% levels by weight to cellulosic material (bleached wood fiber). Each of the fiber/zeolite blends were then added to high density polyethylene (HDPE) in 50%/50% ratio, and blended. The additive/fiber/HDPE blends were the pressed at high temperature (207 degrees C.), and tested for physical properties. As a control, a 50%/50% blend of fiber/HDPE was prepared and pressed. The samples containing the zeolite showed only a minor color change after processing, while the control showed a large color change due to the high temperature effect on the wood fiber in the fiber/HDPE blend. The color change in the control began at approximately 40 degrees C. earlier than in the fiber/HDPE blends containing additives B or D. Physical properties (impact strength, elongation, and flexural modulus) of the zeolite-containing samples were improved as compared to the control.

### Example Set IV

The additives B and D are added in the same ratios to bleached cellulose fibers as above, and are added to polypropylene (PP) in the same ratios as above. These samples are pressed and results in color change and physical properties, compared to the control, similar to the above are obtained.

### Example Set V

The additives B and D are added in the same ratios to bleached cellulose fibers as above, and are added to HDPE and PP in the same ratios as above. These samples are extruded rather than pressed, and fiber/thermoplastic foams are obtained. Results in color change and physical properties, compared to the control, similar to the above are obtained.

### Example Set VI

A combination of cellulosic material (oak wood fiber) and polypropylene (PP), in a relative weight ratio of approximately 55% PP/45% cellulosic material in the form of a pellet was compounded with and without additive B, above. The resulting compositions were injection molded. The composition containing additive B was processed without any color change to the cellulosic material, while the cellulosic material in the composition without additive B turned dark brown and exhibited burning. The full formulation was as follows: Cellulosic material: 40% (oak wood fiber); PP: 48.5%; Lubricant: 0.5% mineral oil; Blowing agent (SAFOAM,RIC-50)*: 1%; Additive B: 2%; Color concentrate: 8% (10% TiO2 in polyethylene carrier)
*RIC 50 is available from Reedy Int'l. Corp.; RIC 50 is a blend of sodium bicarbonate, monosodium citrate, tricalcium phosphate, silicon dioxide, calcium oxide and vegetable oil (50%) in a polyethylene carrier (50%).

### Example Set VII

A combination of cellulosic material (oak wood fiber) is combined with PP homopolymer in a relative weight ratio of approximately 60%-65% cellulosic material/40%-35% PP. An additive package of additive B (1%), SAFOAM FJC (0.5%), lubricant (oxidized HDPE-0.5%-1.0%) and Kraton 1650 (4%) are included. The resulting composite foam is submerged under water for 30 days and it will absorb less than 10% water.

A combination of cellulosic material (pine wood fiber) is combined with PP homopolymer in a relative weight ratio of approximately 60%-65% cellulosic material/40%-35% PP. An additive package of additive B (1%), SAFOAM RIC (0.5%), lubricant (oxidized HDPE-0.5%-1.0%) and Kraton 1650 (4%) are included. The resulting composite foam is submerged under water for 30 days and it will absorb less than 10% water.

Raw wood submerged under the same conditions will absorb at least 100% water, wood/plastic composites will absorb about 30% water. A water absorption of about 15% is sufficient to promote algae and fungal growth.

### Example Set VIII

A combination of cellulosic material (pine wood fiber) is combined with PP in a relative weight ratio of approximately 30% cellulosic material/70% PP. An additive package of additive B (1.4%), blowing agent (sodium bicarbonate, 2%), lubricant (oxidized HDPE, 0.4%) and color concentrate (carbon black in polyethylene carrier, 2%) are included. The composition is injection molded and shows no signs of discoloring or burning of the cellulosic material. The surface characteristics are smooth and free of major imperfections.

All of the patents mentioned and referred to herein are incorporated herein by reference and their disclosures are fully part of this application. The present invention has been described with preferred embodiments. It is to be understood however that modifications and variations may be resorted to, without departing from the spirit and scope of the invention, as those skilled in the art would readily understand. These modifications and variations are considered to be within the scope of the appended claims.

1-2. (canceled)

3. A process for producing cellulosic material-containing foam, said process comprising:
(a) heating foamable material selected from cellulosic material-containing thermoplastic resin and cellulosic material-containing thermosetting resin to a temperature above the melting point of the thermoplastic resin or thermosetting resin to form a melted foamable material;
(b) adding to the melted foamable material zeolite containing foaming agent;
(c) mixing the combination of foamable material and zeolite containing foaming agent under conditions which retard foaming of the foamable material; and
(d) subjecting the combination of foamable material and zeolite containing foaming agent to conditions which induce release of foaming agent.

4. A process for producing foamed cellulosic material-containing product, said process comprising:
(a) mixing zeolite, foaming agent and cellulosic material;
(b) mixing the mixture resulting from step (a) with foamable material selected from thermoplastic resins and thermosetting resins:
(c) heating the mixture resulting from step (b) to a temperature above the melting point of said foamable material to form a melted foamable material;
(d) mixing the melted foamable material from step (c) under conditions which retard foaming of the foamable material; and
(e) subjecting the resulting blend from step (d) to conditions which induce release of foaming agent.

5-7. (canceled)

8. A process for producing foamed cellulosic material-containing product, said process comprising:
(a) mixing zeolite, foaming agent, cellulosic material and foamable material selected from thermoplastic resins and thermosetting resins;
(b) heating the mixture resulting from step (a) to a temperature above the melting point of said foamable material to form a melted foamable material;
(c) mixing the melted foamable material from step (b) under conditions which retard foaming of the foamable material; and
(d) subjecting the resulting blend from step (c) to conditions which induce release of foaming agent.

9. A process for producing foamed cellulosic material-containing product, said process comprising:
(a) mixing zeolite, foaming agent and cellulosic material;
(b) heating foamable material selected from thermoplastic resins and thermosetting resins to a temperature above the melting point of said foamable material to form a melted formable material;
(c) mixing the zeolite, foaming agent and cellulosic material from step (a) with the melted foamable material from step (b) under conditions which retard foaming of the foamable material; and
(d) subjecting the resulting blend from step (c) to conditions which induce release of foaming agent.
